(19) United States
(12) Patent Application Publication
(10) Pub. No.: US 2010/0115150 A1
(43) Pub. Date: May 6, 2010

(54) INFORMATION PROCESSOR

(75) Inventor: Koji HACHIYA, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/542,566

(22) Filed: Aug. 17, 2009

(30) Foreign Application Priority Data
Oct. 31, 2008 (JP) 2008-282368

(51) Int. Cl. G06F 3/00; G06F 1/26

(52) U.S. Cl. 710/19; 713/300

(57) ABSTRACT

According to one embodiment, an information processor includes a power supply module, an interface, an electronic device detector, a notification module, and a power supply controller. The power supply module supplies power. The interface has a power supply function for supplying power from the power supply module to an electronic device even when an operating system is idle. The electronic device detector detects whether the electronic device is connected to the interface. The notification module notifies information indicating that the power supply module supplies power to the electronic device when the electronic device detector has detected that the electronic device is connected to the interface. The power supply controller controls the power supply module to supply power to the electronic device when the electronic device detector has detected that the electronic device is connected to the interface.

### CROSS-REFERENCE TO RELATED APPLICATIONS

This application is based upon and claims the benefit of priority from Japanese Patent Application No. 2008-282368, filed Oct. 31, 2008, the entire contents of which are incorporated herein by reference.

### BACKGROUND

1. Field

One embodiment of the invention relates to an information processor with an interface capable of supplying power to an electronic device connected thereto.

2. Description of the Related Art

In recent years, external devices, such as universal serial bus (USB) (registered trademark) devices, have been in widespread use that can be charged through USB connection to an information processor. The information processor is often provided with a power saving function that automatically shuts off the power if the user does not do any operation with the keyboard or the like to consume less power.

If the information processor enters power saving mode while charging an external device, the charging is interrupted. On the other hand, if the information processor is maintained active even when the user is not using it to only charge the external device, wasteful power is consumed.

In view of this, for example, Japanese Patent Application Publication (KOKAI) No. 2006-53748 discloses a conventional technology for an information processor having a power supply function. According to the conventional technology, even if the power is OFF or in power saving mode, the information processor is capable of supplying power to an external device connected thereto using bus power such as USB bus power.

However, with the conventional technology, the user needs to invoke a utility program after connecting a USB device to the port to enable or disable the USB power supply function. Accordingly, considerable time and effort are required to connect the device to the port to charge it and disconnect it after the charging.

Moreover, the user needs to invoke the utility program also to check whether the USB power supply function operates properly. This checking process necessitates spending time.

Beside, if the information processor is provided with a port that cannot be used for power supply, even when a USB device is erroneously connected to the port, the user is left with no information about it. Consequently, user does not notice that the USB device is not being charged. As a result, when the user disconnects the USB device from the port after a lapse of some time, the USB device remains uncharged.

As described above, according to the conventional technology, by simply connecting a USB device to a USB port, the charging function cannot be reliably made use of. In addition, the procedure to start charging the USB device is cumbersome and also takes considerable time.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary perspective view of an information processor according to an embodiment of the invention;

FIG. 2 an exemplary block diagram of the information processor in the embodiment;

FIG. 3 is an exemplary detailed block diagram of a power supply module of the information processor in the embodiment;

FIG. 4 is an exemplary functional block diagram of the information processor in the embodiment;

FIG. 5 is an exemplary flowchart of the process of enabling a USB power supply function in the embodiment;

FIG. 6 is an exemplary schematic diagram of a popup window in the embodiment;

FIG. 7 is an exemplary schematic diagram of another popup window in the embodiment;

FIG. 8 is an exemplary flowchart of the process of disabling the USB power supply function in the embodiment; and

FIG. 9 is an exemplary schematic diagram of still another popup window in the embodiment.

### DETAILED DESCRIPTION

Various embodiments according to the invention will be described hereinafter with reference to the accompanying drawings. In general, according to one embodiment of the invention, an information processor comprises a power supply module, an interface, an electronic device detector, a notification module, and a power supply controller. The power supply module is configured to supply power. The interface has a power supply function for supplying power from the power supply module to an electronic device even when an operating system is idle. The electronic device detector is configured to detect whether the electronic device is connected to the interface. The notification module is configured to notify information indicating that the power supply module supplies power to the electronic device when the electronic device detector has detected that the electronic device is connected to the interface. The power supply controller is configured to control the power supply module to supply power to the electronic device when the electronic device detector has detected that the electronic device is connected to the interface.

According to another embodiment of the invention, an information processor comprises an interface with a power supply function for supplying power to an electronic device connected to the interface. When the electronic device is connected to the interface in power saving mode in which an operating system is idle, the information processor notifies that power is to be supplied to the electronic device.

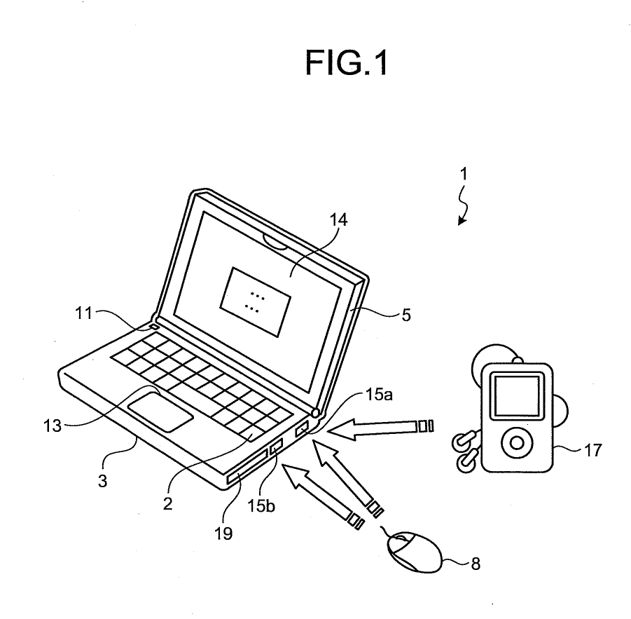

FIG. 1 is a perspective view of an information processor 1 according to an embodiment of the invention. FIG. 1 illustrates, as an example of the information processor 1, a notebook personal computer. The information processor 1 comprises a main body 3 and a display module 5 that is rotatably supported by the main body 3.

The display module 5 comprises a thin film transistor liquid crystal display (TFT-LCD) 14. The TFT-LCD 14 has a display screen at substantially the center of the display module 5. The TFT-LCD 14 is used as a display monitor of the information processor 1, and displays a moving image, a still image, text, graphics, and the like.

With respect to the main body 3, the display module 5 is rotatable between an open position and a closed position. The main body 3 has a flat box-like housing, on which are arranged a keyboard 2, a power button 11, and a touchpad 13.

The keyboard 2 comprises a plurality of input keys. The keyboard 2 is an input device that receives input from a user who is typing the input keys, thereby inputting data to an embedded controller/keyboard controller (EC/KBC) 80.

The power button 11, when pressed, turns on or off the information processor 1. That is, the power button 11 has an activation function.

Located on a side of the main body 3 are USB ports 15a and 15b, and a slot 19 to insert or remove a DVD medium. The USB port 15a is one having a USB power supply function, while the USB port 15b is one not having the USB power supply function. The USB power supply function will be described later.

As will be described in detail later, if an electronic device 17 is a device (17a) with a rechargeable battery, it is connected to the USB port 15a. If the electronic device 17 is a device (17b) not having a rechargeable battery such as a pointing device 8, it can be connected to both the USB ports 15a and 15b.

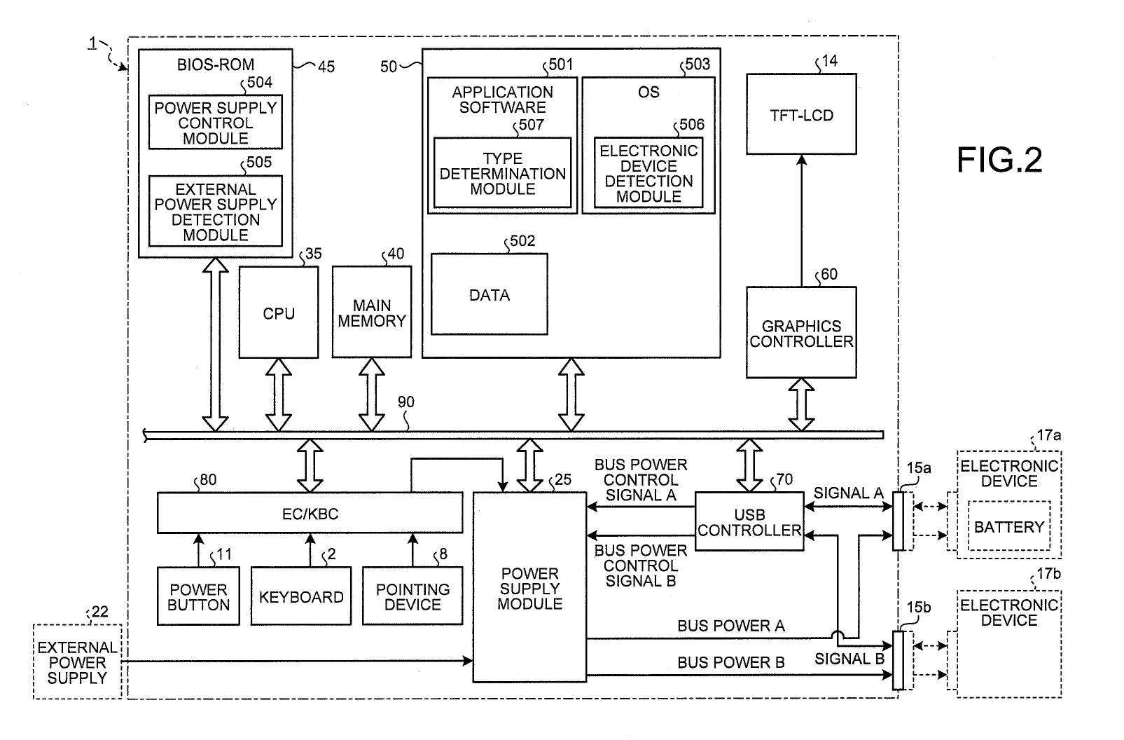

FIG. 2 illustrates a system configuration or constituent elements (hardware) of the information processor 1. Described below is a detailed configuration of the information processor 1.

As illustrated in FIG. 2, the information processor 1 comprises a CPU 35, a main memory 40, a BIOS-ROM 45, an HDD 50, and a graphics controller 60, which are connected to an internal bus 90. The CPU 35 executes various types of software. The CPU 35 executes various types of software. The main memory 40 temporarily stores the software executed by the CPU 35 and data. The BIOS-ROM 45 stores a basic input/output system (BIOS), which is a program for controlling hardware. The HDD 50 stores software and data. The graphics controller 60 controls the display of various types of information and images on the TFT-LCD 14.

The HDD 50 stores application software 501, data 502, and an operating system (OS) 503. Detailed description of the configuration and function thereof will be described in detail later after the description of a detailed configuration of a power supply module 25.

The information processor 1 further comprises a USB controller 70 and the power supply module 25. The USB controller 70 translates data on the internal bus 90 into serial USB signals and vice versa as well as generating a bus power control signal. The power supply module 25 supplies power to the USB controller 70 and other constituent elements, and also supplies bus power through the USB ports 15a and 15b. Among signals generated by the USB controller, those input to the USB port 15a will be referred to as signal A, while those input to the USB port 15b will be referred to as signal B. Both the USB controller 70 and the power supply module 25 are connected to the internal bus 90.

In addition, the information processor 1 further comprises the EC/KBC 80 that converts signals from the keyboard 2, the power button 11, and the pointing device 8, and is connected to the internal bus 90.

To the information processor 1, the electronic devices 17a and 17b are connected via the USB ports 15a and 15b, respectively. The USB port 15a is a USB connector having the USB power supply function in power saving mode, while the USB port 15b is a USB connector not having the USB power supply function.

The term “USB power supply function” as used herein refers to the function of supplying bus power to the external electronic device 17a while the information processor 1 is in idle mode or shut down. A description will be given of the electronic device 17a and the idle (off) mode.

The electronic device 17a is provided with a built-in rechargeable battery. In the embodiment, an electronic device with a built-in rechargeable battery is classified in category A, and thus the electronic device 17a belongs to the category A. On the other hand, an electronic device without a built-in rechargeable battery is classified in category B, and thus the electronic device 17b belongs to the category B.

For example, mobile telephones and music players are provided with a built-in rechargeable battery and classified in the category A, while USB hubs and human interface devices (HIDs) such as a mouse, a keyboard, a printer, a USB camera, and an audio device are not provided with a built-in rechargeable battery and classified in the category B.

Described below is how to wake up or activate the information processor 1 and bring it in the idle or off mode. The information processor 1 can be woken up in various manners. In general, the user presses the power button 11 on the main body 3 (see FIG. 1) to activate the information processor 1.

More specifically, when the user presses the power button 11, a control signal instructing to activate the information processor 1 is issued to the power supply module 25. Upon receipt of the control signal, the power supply module 25 turns on a power distribution switch to supply power to the constituent elements of the information processor 1.

Alternatively, for example, the information processor 1 may wake up in response to a wake-up instruction signal issued at a predetermined time or issued by an instruction received from the outside through an electronic communication line.

Next, how to bring the information processor 1 in the idle or off mode will be described. The term “idle (off) mode” as used herein refers to the mode in which the information processor 1 (computer) is shut down or in standby or power saving mode, and the OS 503 is idle or not active.

To shut down the information processor 1, generally, for example, the user opens the shut down window while the OS 503 is active and clicks “shut down”. According to an shut-down (deactivation) instruction designated by this clicking, a predetermined shut-down sequence, such as storing necessary data in the HDD, is performed under the control of the OS 503.

To let the information processor 1 enter power saving mode (standby mode), in a similar manner as to shut down the information processor 1, the user may open a window and click “standby mode” or the like. The information processor 1 may also be set to automatically enter standby mode after a certain period of inactivity from the keyboard or the like.

While FIG. 2 illustrates the information processor 1 of the embodiment as having the two USB ports 15a and 15b, the number of USB ports is not limited to two. There may be one or more than three USB ports. Besides, the information processor 1 may be provided with IEEE 1394 interfaces, such as an IEEE 1394 controller and IEEE 1394 ports (not illustrated), in place of the USB interfaces such as the USB controller 70 and the USB ports 15a and 15b. The information processor 1 may also be provided with both the USB interfaces and IEEE 1394 interfaces. Alternatively, the information processor 1 may be provided with a Power over Ethernet (registered trademark) according to the IEEE 802.3af standard.

Any interface capable of transferring a signal and providing bus power may suffice as that of the information processor 1 of the embodiment.

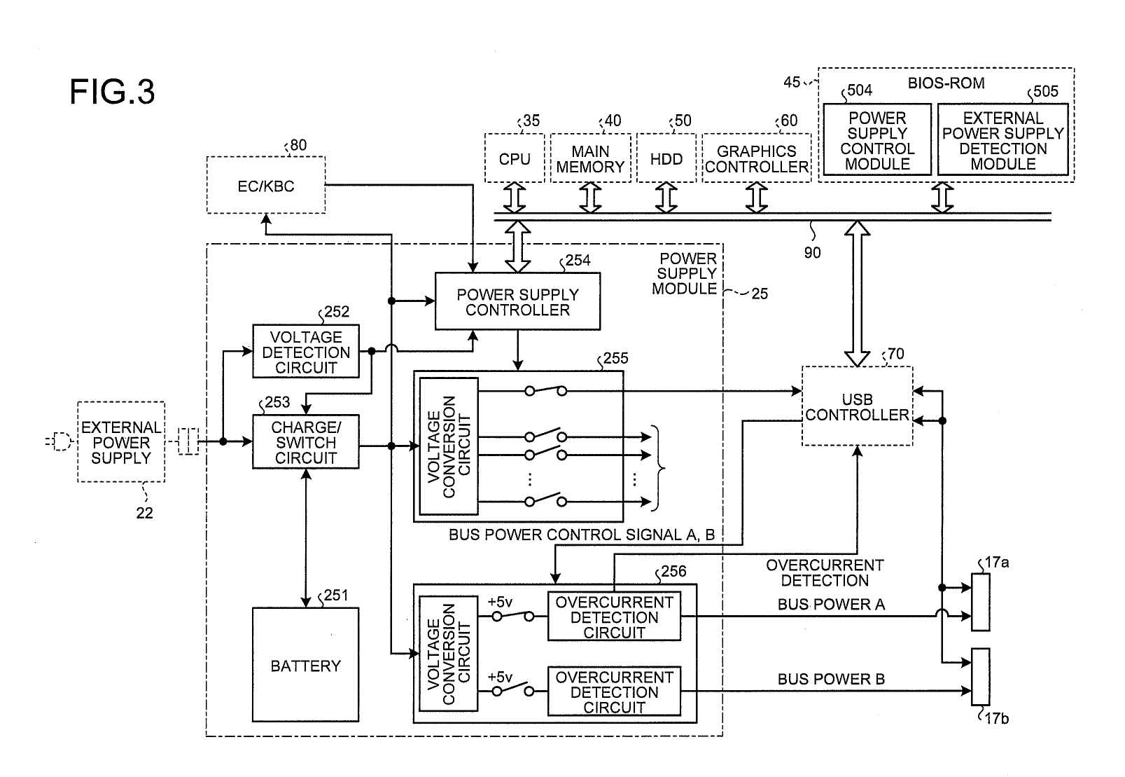

FIG. 3 illustrates the detailed configuration of the power supply module 25. The power supply module 25 comprises a rechargeable battery 251, a voltage detection circuit 252, a charge/switch circuit 253, a power supply controller 254, a power distribution switch 255, and a bus power switch 256.

The voltage detection circuit 252 detects whether an external power supply 22 is connected to the information processor 1. The charge/switch circuit 253 receives from the voltage detection circuit 252 a signal indicating whether the external power supply 22 is connected to the information processor 1. The charge/switch circuit 253 switches between the battery 251 and the external power supply 22 according to the signal received from the voltage detection circuit 252. In addition, the charge/switch circuit 253 charges the battery 251 with power from the external power supply 22.

The power supply controller 254 is connected to the internal bus 90 and receives a power control signal. The power supply controller 254 controls the power supply module 25 according to the power control signal as well as outputting power supply information, such as information on whether the external power supply 22 is connected to the information processor 1, to the internal bus 90.

The power distribution switch 255 receives a control signal from the power supply controller 254 and distributes power to the USB controller 70 and other constituent elements while turning on/off the power supply. The bus power switch 256 switches on/off USB bus power under the control of the USB controller 70.

Described below is power supply from the battery 251 to the power supply module 25.

The power supply module 25 is supplied with power from the external power supply 22. The external power supply 22 may be, for example, a commercial power supply (100 V, 50/60 Hz), and alternating current (AC) power received therefrom is converted by an AC adapter to direct current (DC) power. The power supply module 25 may be directly supplied with commercial power. In this case, the power supply module 25 converts the commercial power from AC to DC power therein.

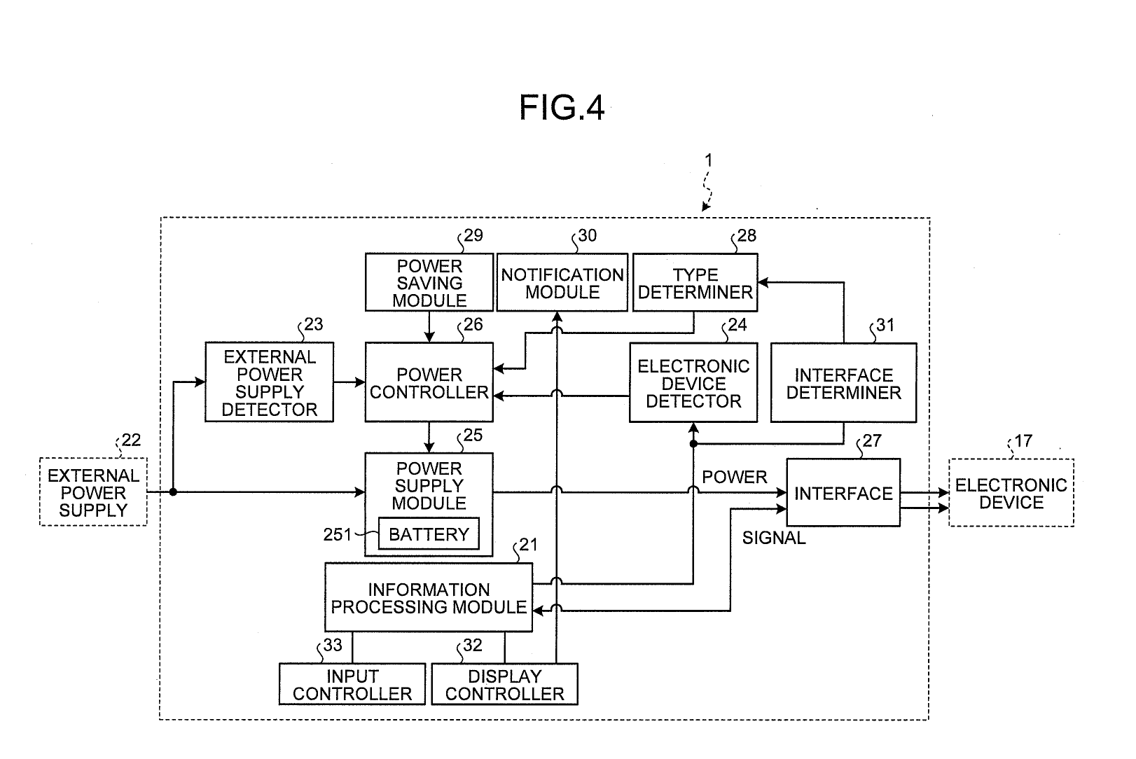

The rechargeable battery 251 of the power supply module 25 may be, for example, a lithium ion battery or a nickel-metal-hydride battery. When an external power supply detector 23 (see FIG. 4), which will be described later, detects no external power supply, the built-in rechargeable battery 251 supplies power to the constituent elements of the information processor 1.

On the other hand, when the external power supply detector 23 detects the external power supply 22, power from the external power supply 22 is preferentially supplied to the constituent elements of the information processor 1. Besides, when the battery 251 is running low, the battery 251 is charged with the external power supply 22.

The power supply module 25 converts power from the external power supply 22 or the battery 251 to a voltage level suitable for the respective constituent elements of the information processor 1 such as, for example, 5 V or 3.3 V, and then distributes the power to them. The power is distributed via the power distribution switch 255 capable of turning on/off power supply with respect to each of the constituent elements or each group of constituent elements.

With reference to FIGS. 2 and 3, a description will be given of the detailed operation of the information processor 1 related to power supply control.

If the external power supply 22 is connected to the information processor 1, the battery 251 is charged with power from the external power supply 22 via the charge/switch circuit 253 of the power supply module 25 as illustrated in FIG. 3. The charge/switch circuit 253 has an overcharge protection function or the like and stops charging the battery 251 when it is fully charged.

A determination as to whether the external power supply 22 is connected to the information processor 1 is based on whether a voltage detected by the voltage detection circuit 252 exceeds a predetermined threshold. If the external power supply is connected to the information processor 1, the charge/switch circuit 253 preferentially outputs power from the external power supply 22.

On the other hand, if the external power supply 22 is not connected to the information processor 1, the charge/switch circuit 253 outputs power from the battery 251.

Regardless of whether the information processor 1 is active or idle, the power output from the charge/switch circuit 253 is supplied to the power supply controller 254, the power distribution switch 255, and the bus power switch 256 of the power supply module 25, and also to the EC/KBC 80. The power supplied from the charge/switch circuit 253 to the bus power switch 256 is converted by a voltage conversion circuit to a voltage level not exceeding a predetermined threshold, and is supplied to the electronic devices 17a and 17b via overcurrent detection circuits. The results of overcurrent detection are sent to the USB controller 70.

If the user presses the power button 11 while the information processor is idle (off), a signal is issued and sent to the power supply controller 254 of the power supply module 25 via the EC/KBC 80.

The power supply controller 254 recognizes the signal issued in response to the depression of the power button 11 as a signal instructing to wake up or activate the information processor 1. Accordingly, the power supply controller 254 instructs the power distribution switch 255 to close all switches and thereby supply power to the constituent elements of the information processor 1.

After the constituent elements of the information processor 1 are supplied with power, first, the BIOS stored in the BIOS-ROM 45 is invoked. After that, the OS 503 stored in the HDD 50 is booted up.

Once the OS 503 is booted up, for example, according to an instruction from the user, the application software 501 can be activated.

The BIOS implements a power supply control module 504 and an external power supply detection module 505 in the BIOS-ROM 45. The OS 503 implements an electronic device detection module 506. The application software 501 implements a type determination module 507.

The power supply control module 504 controls power supply to the constituent elements of the information processor 1 as well as controlling bus power supply through the USB ports 15a and 15b.

The external power supply detection module 505 monitors whether the external power supply 22 is connected to the information processor 1 based on information received from the voltage detection circuit 252 of the power supply module 25. When the external power supply 22 is connected to the information processor 1, the external power supply detection module 505 stores, as appropriate, a flag indicating it in the memory.

The electronic device detection module 506 monitors whether the external electronic device 17 (17a, 17b) is connected to the information processor 1 based on information received from the USB controller 70. When the electronic device 17 is connected to the information processor 1, the electronic device detection module 506 stores, as appropriate, a flag indicating it in the memory.

The type determination module 507 determines the type of the electronic device 17 connected to the information processor 1 based on information received from the USB controller 70. More specifically, the type determination module 507 determines whether the electronic device 17 is one belonging the category A, i.e., the electronic device 17a, or one belonging the category B, i.e., the electronic device 17b. Thus, the type determination module 507 stores, as appropriate, a flag indicating the type or category in the memory.

While the information processor 1 is active, power is supplied to the USB controller 70. The USB controller 70 converts a signal on the internal bus 90 into a USB signal (a communication signal with the external electronic device 17a or 17b connected via the USB port 15a or 15b), and vice versa. The USB controller 70 also performs the ON/OFF control of bus power supplied to the external electronic devices 17a and 17b through the USB ports 15a and 15b, respectively.

For example, the USB controller 70 controls bus power supply such that the overall bus power is ON in the initial state. The USB controller 70 performs this control by sending control signals (bus power control signals A and B) to the bus power switch 256 of the power supply module 25 (see FIG. 3).

The bus power switch 256 converts power from the external power supply 22 or the battery 251 to a predetermined voltage level, for example, 5 V. Then, the bus power switch 256 supplies the power to the USB ports 15a and 15b as bus power A and bus power B, respectively, through switches that are turned on/off according to the bus power control signals A and B.

When the information processor is active, bus power is supplied to both the external electronic devices 17a and 17b, while if the information processor 1 is idle or off, only the electronic device 17a is supplied with the bus power A through the USB port 15a.

While the information processor 1 is active, the software modules, i.e., the power supply control module 504, the external power supply detection module 505, the electronic device detection module 506, and the type determination module 507, operate all the time (or at appropriate time intervals).

Accordingly, if the external power supply 22 is disconnected or if the type of the electronic device 17 (17a, 17b) changes or is disconnected while the information processor 1 is active, such changes can be recognized.

As a result, the external power supply detection module 505 always updates the flag indicating whether the external power supply 22 is connected to the information processor 1. Similarly, the electronic device detection module 506 always updates the flag indicating whether the external electronic device 17 (17a, 17b) is connected to the information processor 1 and, if any, the type determination module 507 updates the flag indicating the type of the external electronic device 17.

While the information processor 1 is active, the power supply control module 504 generally controls to provide bus power supply through the USB ports 15a and 15b.

If the external power supply 22 is not connected to the information processor 1, the power supply control module 504 may control to stop bus power supply even if the information processor 1 is active. This is because, depending on the power capacity of the battery 251, information processing in the information processor 1 may be given higher priority than bus power supply to the external electronic device 17 (17a, 17b).

When an instruction is issued to, for example, shut down or suspend the information processor 1, the power supply control module 504 of the BIOS refers to the flag indicating whether the external power supply 22 is connected to the information processor 1. Further, the power supply control module 504 refers to the flag indicating whether the external electronic device 17 (17a, 17b) is connected to the information processor 1 and, if any, the flag indicating the type of the external electronic device 17.

If the reference to the flags results in that the external power supply 22 is connected to the information processor 1 and that the external electronic device 17 is connected to the information processor 1, the power supply control module 504 instructs the power supply controller 254 of the power supply module 25 to maintain power supply to the USB controller 70 even when the information processor 1 enters the idle or off mode. In addition, the power supply control module 504 instructs the USB controller 70 to maintain bus power supply even when the information processor 1 enters the idle or off mode.

In response to the instruction to maintain bus power supply, the USB controller 70 sets the bus power control signals A and B to maintain the bus power switch 256 of the power supply module 25 ON after the information processor 1 enters the idle or off mode. At this time, by referring to the flag indicating the type of the electronic device 17 connected to the information processor 1, the USB controller 70 may set the bus power control signals A and B such that if the electronic device 17 is one belonging to the category A, i.e., the electronic device 17a, bus power supply to the electronic device 17a is maintained, while if the electronic device 17 is one belonging to the category B, i.e., the electronic device 17b, bus power supply to the electronic device 17b is stopped.

Incidentally, when an instruction is issued to shut down the information processor 1 (when the information processor 1 is turned off), as exemplified by the power distribution switch 255 in FIG. 3, the power supply control module 504 may stop power supply to the constituent elements of the information processor 1 except for the USB controller 70.

On the other hand, when an instruction is issued to, for example, suspend the information processor 1 based on the power saving function, power supply may be maintained to predetermined constituent elements such as, for example, the main memory 40 in addition to the USB controller 70, while power supply to others may be stopped.

With reference to FIG. 4, a description will be given of the operation of the information processor 1, especially the operation related to power supply control. FIG. 4 is a functional block diagram of the information processor 1.

As illustrated in FIG. 4, the information processor 1 comprises the external power supply detector 23, an electronic device detector 24, a power controller 26, an interface 27, a type determiner 28, a power saving module 29, a notification module 30, an interface determiner 31, an information processing module 21, a display controller 32, and an input controller 33. The same function as these modules may be implemented in either software or hardware, or a combination thereof.

The information processing module 21 is provided with the display controller 32 and the input controller 33. The display controller 32 issues instructions to display various types of information on the TFT-LCD 14 (see FIG. 2). The input controller 33 receives input from the user through the keyboard 2, the pointing device 8 (see FIGS. 1 and 2), or the like. The pointing device 8 may be, for example, a USB mouse (see FIG. 1).

The processing of the information processing module 21 includes information processing according to part of the OS and the BIOS as well as various types of application software.

The interface 27 connects the electronic device 17 to the information processor 1. The interface 27 may be USB or the like that communicates signals with the electronic device 17 and supplies power thereto through a single connector.

The signals include one that contains information on the type of the external electronic device 17 and an identification signal that identifies a USB connector to which the electronic device 17 is connected.

The interface 27, such as USB, has hot plug function. With the hot plug function, even if the external electronic device 17 is connected to the interface 27 after the OS is booted up, it is possible to recognize that the electronic device 17 is connected to the interface 27 and to identify the type and category of the electronic device 17.

The interface determiner 31 determines that the electronic device 17 is connected to a USB connector from a signal received via the interface 27, such as USB, and the information processing module 21. Upon recognizing that the electronic device 17 is connected to a USB connector, the interface determiner 31 determines the type of the USB connector from the received signal.

The electronic device detector 24 detects that the external electronic device 17 is connected to the interface 27 through the interface 27, such as USB, and the information processing module 21. The information processing module 21 communicates a signal with the external electronic device 17 through a USB or the like. With this signal, it can be recognized whether the external electronic device 17 is connected to the interface 27.

The type determiner 28 determines the type of the external electronic device 17 based on the signal that contains information on the type of the electronic device 17, and classifies it into a category. As previously described in connection with FIG. 2, an electronic device with a built-in rechargeable battery is classified in the category A, while an electronic device without a built-in rechargeable battery is classified in the category B.

When the electronic device 17a belonging to the category A is connected to the USB port 15a, bus power is supplied to the electronic device 17a through the interface 27. The bus power charges the built-in battery of the electronic device 17a belonging to the category A.

The charging of the battery continues at least while the information processor 1 is active. Although depending on the type of the electronic device 17a connected, generally, the electronic device 17a can operate with the bus power while the battery is being charged.

The electronic device detector 24 and the type determiner 28 store in a memory a flag indicating whether the electronic device 17 is connected to a USB port, a flag indicating the type of the electronic device 17 connected, a flag indicating the type of the USB port, and the like.

From signals communicated over a serial bus, when the type determiner 28 determines that the external electronic device 17 connected to a USB connector is classified in the category A, and also, the USB connector is the USB port 15a having the USB power supply function, the notification module 30 sends an instruction to the display controller 32 to display a popup window to enable the USB power supply function.

Upon receipt of the instruction from the notification module 30, the display controller 32 displays the popup window to enable the USB power supply function on the TFT-LCD 14 (see FIG. 2).

Having received input to perform the USB power supply function that the user provides using the keyboard 2, the pointing device 8 (see FIGS. 1 and 2), or the like from the popup window, the input controller 33 sends an instruction to perform the USB power supply function to the power controller 26.

Upon receipt of the instruction to perform the USB power supply function from the input controller 33, the power controller 26 controls the USB power supply function with respect to the power supply module 25. Described below is a series of processes performed by the power controller 26 including the USB power supply function control.

The power controller 26 detects whether the external power supply 22 is connected to the information processor 1. A determination as to whether the external power supply 22 is connected to the information processor 1 can be made by, for example, comparing a power supply voltage from the external power supply 22 with a predetermined threshold. When detecting that the external power supply 22 is connected to the information processor 1, the power controller 26 stores in a memory a flag indicating that the external power supply 22 is connected to the information processor 1.

The power controller 26 performs various controls on the power supply module 25. For example, the power controller 26 sends the power supply module 25 instructions such as to wake up or activate the information processor 1, to make the information processor 1 idle or off, and to enable the USB power supply function.

First, the control to wake up or activate the information processor 1 will be described. The power controller 26 controls the power supply module 25 to supply power to the constituent elements of the information processor 1. With this, for example, the BIOS is read from the BIOS-ROM 45, the OS 503 is read from the HDD 50, and they are sequentially booted.

After the booting of the OS 503, various types of information processing can be performed by activating various types of application software such as word processing software and spreadsheet software.

Once the OS 503 is booted up, signals can be communicated with the external electronic device 17 connected to the information processor 1 through the interface 27.

Next, the control to let the information processor 1 idle or off will be described. The power controller 26 sends a control signal to the power supply module 25 to turn off power supply to the constituent elements of the information processor 1.

According to the control signal, the power supply module 25 turns off the power distribution switch 255 (see FIG. 3) that supplies power to each constituent element. The power distribution switch 255 is capable of turning off power supply with respect to each of the constituent elements or each group of constituent elements.

A description will now be given of the USB power supply function provided by the information processor 1 of the embodiment. The term “USB power supply function” as used herein refers to a function of supplying power to the external electronic device 17a while the information processor 1 is idle or off. Described below is the USB power supply function performed by the power controller 26.

As described above, it is assumed that the electronic device detector 24 stores a flag indicating whether the external electronic device 17 is connected to the information processor 1. Upon receipt of an instruction to make the information processor 1 idle or off, the power controller 26 refers to the flag. When the external electronic device 17 is connected to the information processor 1, the power controller 26 controls the power supply module 25 to turn off power supply to the constituent elements of the information processor 1 while continuing to supply bus power to the external electronic device 17.

More specifically, for example, the switches of the power distribution switch 255 are set to maintain power supply to the USB controller 70 (see FIG. 2) that constitutes the interface 27 but to turn off power supply to others.

With this power supply control, even in the idle or off mode, the information processor 1 is capable of continuing to supply bus power to the external electronic device 17 connected thereto, if any.

As a connector to connect the external electronic device 17, the information processor 1 is provided with the USB port 15a having the USB power supply function and the USB port 15b not having the USB power supply function.

In other words, even in the idle or off mode, the information processor 1 is capable of supplying the bus power A (see FIG. 2) to the external electronic device 17a through the USB port 15a having the USB power supply function.

On the other hand, the USB port 15b is supplied with the bus power B (see FIG. 2). However, since the USB port 15b does not have the USB power supply function, the information processor 1 cannot supply power through the USB port 15b while in the idle or off mode.

With conventional technologies, if the information processor 1 is provided with a plurality of USB connectors, every time the user connects the external electronic device 17 to one of the USB connectors, he/she is required to check whether the USB connector has the USB power supply function.

Consequently, if the user erroneously connects the external electronic device 17 to a USB connector not having the USB power supply function and does not check whether the USB connector has the USB power supply function, the user is not aware of this until he/she checks the charged state of the external electronic device 17.

On the other hand, according to the embodiment, when the external electronic device 17 is connected to a USB connector not having the USB power supply function, the notification module 30 of the information processor 1 notifies the user of this through a popup window. Thus, it is possible to avoid the situation as described above.

Described below is the popup notification function provided by the information processor 1 of the embodiment. The term “popup notification function” as used herein refers to a function of notifying that the USB power supply function is to be enabled when the external electronic device 17 is connected to the USB port 15a having the USB power supply function.

The electronic device 17 connected to the information processor 1 includes those classified in the category B. Examples of electronic devices classified in the category B include a mouse and a scanner that do not need to be recharged. Such electronic devices are not affected even if bus power supply to them is turned off upon the information processor 1 entering the idle or off mode.

When all the electronic devices connected to the information processor 1 are classified in the category B, it is pointless to supply bus power to them through the interface 27 after the information processor 1 becomes idle. In other words, if bus power supply is maintained while the information processor 1 is idle, then power is unnecessarily supplied to the USB controller 70 of the interface 27.

To avoid such wasteful power consumption, preferably, even if the electronic device 17 is connected to the information processor 1, the type determiner 28 determines the type of the electronic device 17 connected. When all the electronic devices connected to the information processor 1 belong to the category B, the information processor 1 stops supplying power to the USB controller 70 to terminate bus power supply upon entering the idle or off mode.

As a result, wasteful power consumption can be prevented, and thereby power saving for the information processor 1 can be achieved.

Further, according to the embodiment, the conditions to supply bus power even while the information processor is idle or off specify that, in addition to the electronic device 17, the external power supply 22 is connected to the information processor 1.

When the external power supply detector 23 detects that the external power supply 22 is not connected to the information processor 1, bus power supply to the external electronic device 17 may be terminated even if the information processor 1 is active. With this termination of bus power supply, the consumed power of the battery 251 can be reduced.

Recent information processors, especially portable information processors such as notebook personal computers, are often equipped with a power saving function such as suspend or hibernation mode. The power saving function such as suspend or hibernation mode is effective in terms of power saving. However, when the user charges an electronic device such as a mobile telephone by connecting it to the information processor, the power saving function, when automatically activated, may stop the charging of the electronic device.

On the other hand, if power saving function such as suspend or hibernation mode is cancelled to preferentially perform the charging of the electronic device, the power saving function has to be set again after completion of the charging process. This decreases user convenience.

Therefore, in the information processor 1 of the embodiment, the power saving module 29, which implements the power saving function, outputs a power supply control instruction for power saving to the power controller 26. The power supply control instruction is handled in the same manner as an instruction to shut down the information processor 1.

As a result, when power supply to almost all the constituent elements is turned off in power saving mode such as suspend or hibernation mode, it is possible to maintain bus power supply through the interface 27. Thus, an electronic device such as a mobile telephone can be continuously charged even in power saving mode.

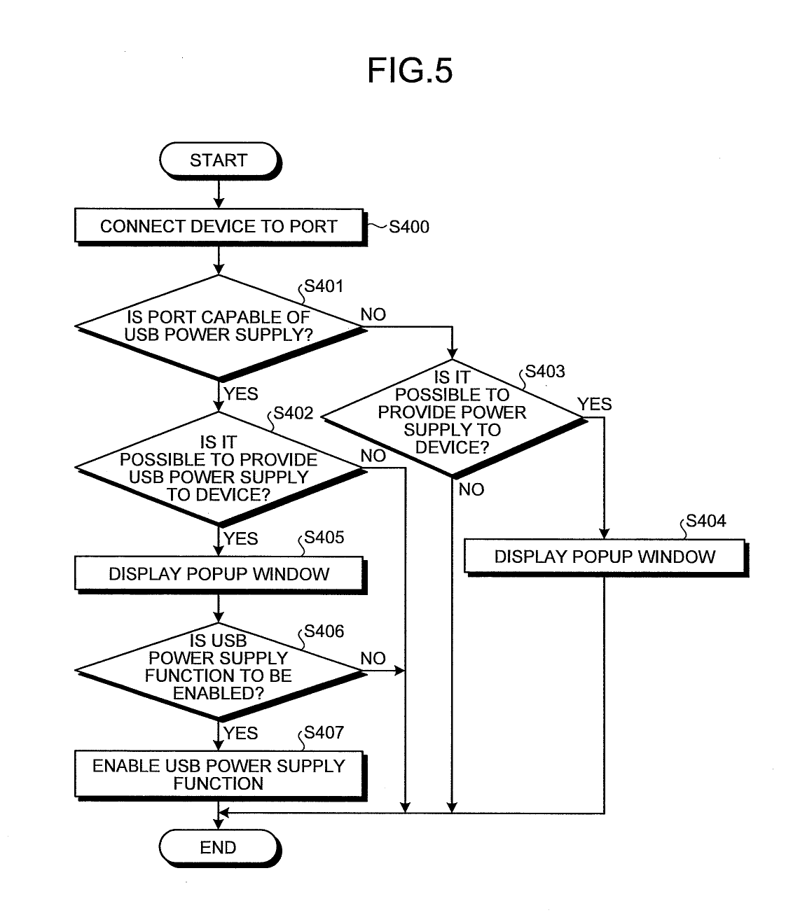

FIG. 5 is a flowchart of the process of enabling the USB power supply function when a device that is chargeable through a USB port is connected to the information processor 1, in which the user is notified that the USB power supply function is to be enabled.

First, the electronic device detector 24 detects that the external electronic device 17 is connected to a USB port based on a signal received via the interface 27 (S400).

The interface determiner 31 determines, through the interface 27, whether the USB port, to which the external electronic device 17 is connected, is capable of USB power supply (S401).

When the external electronic device 17 is connected to the USB port 15a having the USB power supply function, the interface determiner 31 determines that the USB port is capable of USB power supply (Yes at S401). On the other hand, when the external electronic device 17 is connected to the USB port 15b not having the USB power supply function, the interface determiner 31 determines that the USB port is not capable of USB power supply (No at S401).

The type determiner 28 determines whether USB power supply can be provided to the electronic device 17 connected to the USB port (S402). More specifically, the type determiner 28 determines whether the electronic device 17 is provided with a built-in battery and classified in the category A based on a signal indicating the type of the electronic device included in signals communicated over a serial bus.

When the electronic device 17a with a built-in battery (see FIG. 2) is connected to the USB port, the type determiner 28 detects the battery and determines that USB power supply can be provided to the electronic device 17 (Yes at S402). On the other hand, when the electronic device 17b without a built-in battery (see FIG. 2) is connected to the USB port, the type determiner 28 detects no battery and determines that USB power supply cannot be provided to the electronic device 17 (No at S402).

When it is determined that USB power supply can be provided to the electronic device 17 (Yes at S402), the notification module 30 issues an instruction to display a popup window on the TFT-LCD 14 to inquire whether to enable the USB power supply function (S405).

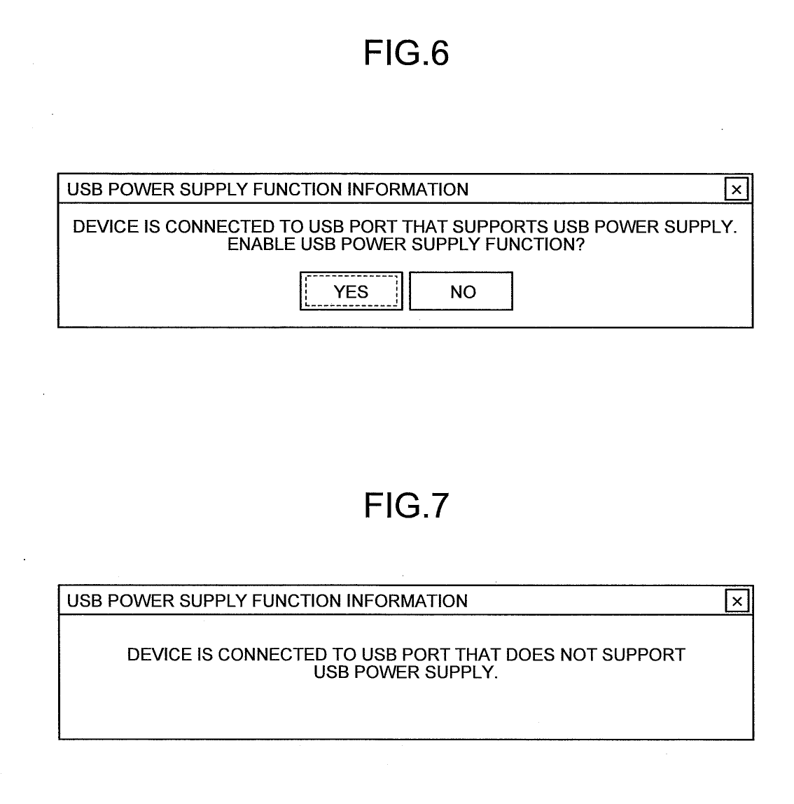

FIG. 6 illustrates an example of the popup window displayed when a device is connected to a USB port that supports USB power supply. As illustrated in FIG. 6, according to the instruction from the notification module 30, the display controller 32 displays on the TFT-LCD 14 a message such as “A device is connected to a USB port that supports USB power supply. Enable USB power supply function?”.

When it is determined that the USB port is not capable of USB power supply (No at S401), the type determiner 28 determines whether, power supply can be provided to the electronic device 17 connected (S403).

If the type determiner 28 determines that power supply can be provided to the electronic device 17 (Yes at S403), the notification module 30 issues an instruction to display a popup window on the TFT-LCD 14 to notify the user of the availability of USB power supply (S404).

FIG. 7 illustrates an example of the popup window displayed when a device is connected to a USB port that does not support USB power supply. As illustrated in FIG. 7, the display controller 32 displays on the TFT-LCD 14 a message such as “A device is connected to a USB port that does not support USB power supply”.

Having received input from the popup window displayed by the notification module 30, the input controller 33 determines whether “YES” (see FIG. 6) is selected by the user (S406).

When the input controller 33 determines that “YES” is selected (Yes at S406), the power controller 26 enables the USB power supply function, and controls the power supply module 25 to supply power to the external electronic device 17 (S407).

On the other hand, when it is determined that power supply cannot be provided to the electronic device 17 (No at S402 and S403), the power controller 26 does not enable the USB power supply function, and the process ends. In addition, also when the input controller 33 determines that “NO” is selected (No at S406), the power controller 26 does not enable the USB power supply function, and the process ends.

As described above, when a device that is chargeable through a USB port is connected to the information processor 1, the user is inquired as to whether the USB power supply function is to be enabled. After receiving input from the user to enable the USB power supply function, the USB power supply function is enabled.

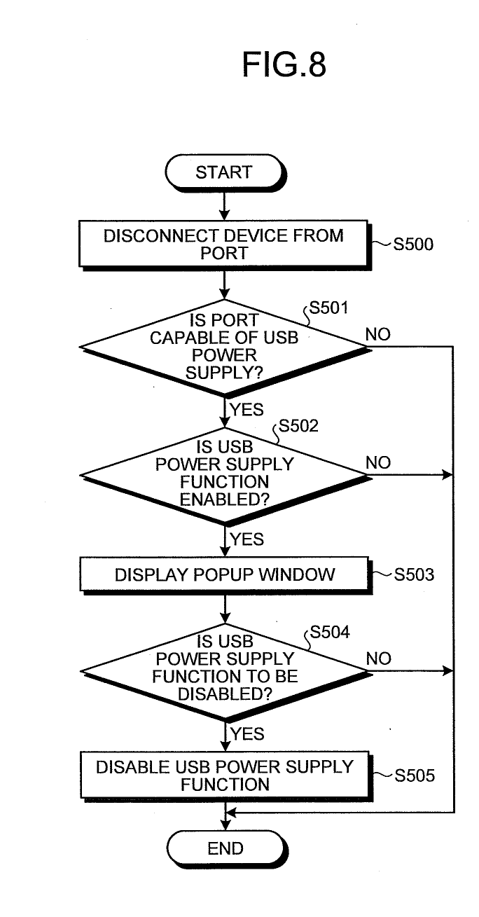

FIG. 8 is a flowchart of the process of disabling the USB power supply function when a device that has been charged through a USB port is disconnected from the information processor 1, in which the user is notified that the USB power supply function is to be disabled.

First, the electronic device detector 24 detects that the external electronic device 17 is disconnected from a USB port based on a signal received via the interface 27 (S500).

The interface determiner 31 determines, through the interface 27, whether the USB port, from which the external electronic device 17 is disconnected, is capable of USB power supply (S501).

When the external electronic device 17 is connected to the USB port 15a having the USB power supply function, the interface determiner 31 determines that the USB port is capable of USB power supply (Yes at S501). On the other hand, when the external electronic device 17 is connected to the USB port 15b not having the USB power supply function, the interface determiner 31 determines that the USB port is not capable of USB power supply (No at S501).

When it is determined that the USB port is capable of USB power supply (Yes at S501), the power controller 26 determines whether the USB power supply function is enabled (S502).

When it is determined that the USB power supply function is enabled (Yes at S502), the notification module 30 issues an instruction to display a popup window on the TFT-LCD 14 to inquire of the user whether to disable the USB power supply function (S405)

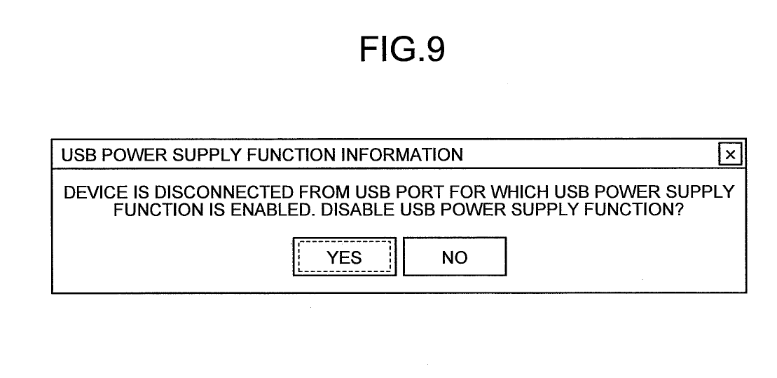

FIG. 9 illustrates an example of the popup window displayed when a device is disconnected from a USB port. As illustrated in FIG. 9, according to the instruction from the notification module 30, the display controller 32 displays on the TFT-LCD 14 a message such as “A device is disconnected from a USB port for which USB power supply function is enabled. Disable USB power supply function?”.

The power controller 26 checks whether “YES” (see FIG. 9) is selected by the user on the popup window (S504).

When the input controller 33 has received input indicating “YES” (Yes at S504), the power controller 26 disables the USB power supply function, and the power supply module 25 stops supplying power to the external electronic device 17 (S505).

On the other hand, when the USB port is not capable of USB power supply (No at S501), when the USB power supply function is not enabled (No at S502), and when “YES” is not selected (No at S504), the power controller 26 performs no specific operation, and the process ends.

As described above, according to the embodiment, when a device is connected to or disconnected from a USB port, the information processor 1 notifies the user of this event to check whether he/she wishes to enable/disable the USB power supply function. Thus, the USB power supply function can be used reliably and effectively.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processor comprising:
a power supply;
a first interface configured to supply power from the power supply to an electronic device;
an electronic device detector configured to detect whether the electronic device is connected to the interface;
a notification module configured to provide an indication that the power supply supplies power to the electronic device when the electronic device detector detects that the electronic device is connected to the interface; and
a power supply controller configured to control the power supply when the electronic device detector detects that the electronic device is connected to the interface.

2. The information processor of claim 1, further comprising:
a second interface configured not to supply power; and
an interface determining module configured to determine which interface the electronic device is connected to when the electronic device detector detects that the electronic device is connected to either the first interface or the second interface, wherein
the notification module is configured to provide an indication that power is not to be supplied to the electronic device when the interface determining module determines that the electronic device is connected to the second interface.

3. The information processor of claim 1, wherein
the electronic device detector is configured to further detect whether the electronic device is chargeable, and
the notification module is configured to provide an indication that power is to be supplied to the electronic device when the electronic device detector detects that the electronic device is chargeable.

4. The information processor of claim 1, wherein
the notification module is configured to provide an indication that the power supply is to be stopped when the electronic device is disconnected from the first interface, and
the power supply controller is configured to terminate power supply to the electronic device when the electronic device is disconnected from the first interface.

5. The information processor of claim 1, further comprising a display, wherein
the notification module is configured to display the notification on the display.

6. An information processor comprising an interface with a power supply function for supplying power to an electronic device connected to the interface, wherein
the information processor is configured to provide an indication that power is to be supplied to the electronic device when the electronic device is connected to the interface in a power saving mode in which an operating system is idle.
